(19) United States
(12) Patent Application Publication
(10) Pub. No.: US 2009/0129434 A1
(43) Pub. Date: May 21, 2009

(54) Method And Device For Detecting A Rise In Temperature In A Cold Chamber

(75) Inventors: Alexandre Creus, Haut-Le-Wastia (BE); Olivier Rihoux, Saint-Servais (BE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: FU-GU, Malonne (BE)

(21) Appl. No.: 11/921,170

(22) PCT Filed: Jun. 1, 2006
(86) PCT No.: PCT/EP2006/062827

§ 371 Date: Nov. 28, 2007

(30) Foreign Application Priority Data
Jun. 3, 2005 (EP) 05104868.4

(51) Int. Cl. G01K 3/04

(52) U.S. Cl. 374/107; 374/E03.004

(57) ABSTRACT

The invention concerns a method for detecting a temperature rise, in particular a preservation temperature, in a cooler designed for preserving products, comprising liquefying a detection substance (6), contained in a first zone (2), by a temperature rise and moving the liquefied detection substance (6) into a second zone (3) of said chamber thereby enabling said temperature rise to be detected. The invention also concerns a device (1) for implementing said method.

The present invention relates to a method for detecting a rise in temperature, particularly a preservation temperature, in a cold chamber intended for preserving products, comprising:
an at least partial liquefaction of a detection substance that is housed in a first zone of said chamber, which liquefaction is caused by a rise in temperature, particularly an accidental rise in temperature, in said cold chamber, and
a displacement of a volume of liquefied detection substance into a second zone of said chamber, thereby allowing detection of said rise in temperature.

Such a method is known from Swiss patent no. 625 618. The method disclosed in said patent comprises a liquefaction of part of a frozen detection liquid in a first zone under the effect of a rise in temperature, and a displacement of the liquefied part towards a second zone located below the first. The melting point of the liquid is −10° C. If the freezing chamber, normally at −24° C., undergoes a rise in temperature of at least 10° C., the detection substance liquefies and flows to the bottom of the container. The method can be carried out a certain number of times, since all that is required is to solidify the liquid in the first zone by placing the latter at the bottom and then turning it over, that is to say placing the first zone at the top so as to detect a rise in temperature, and so on, it being possible for the first zone to serve as the second zone and vice versa.

Unfortunately, such a method is limited with regard to detection. This is because it is known that a rise in temperature of around 2 to 6° C. for food products frozen at −24° C. alters the taste of the food without any real risk of poisoning, whereas a rise of more than 6° C. may be enough to present a serious risk of food poisoning, especially if it takes place a number of times. Taking the example of a food product that is transported, it is not acceptable that the product might undergo during transport a first rise in temperature that will not be detected and then, when the product is placed in the freezing chambers, it might undergo a second rise in temperature which will again not be detected. If the product were to undergo another rise in temperature in the home of the consumer, the product would certainly be deemed to be unfit for consumption, and would in actual fact not be good publicity for the company producing said product. However, with a method of the type disclosed in the Swiss patent, these three consecutive rises in temperature might not be detected and it would be thought that the product had been perfectly preserved.

Furthermore, due to the egg-timer shape and the constriction, the device lacks rapidity of detection.

Other methods of the same type also exist, for example the method of patent EP 0 606 033. This method is also described at the start and it has the same features as the method of the Swiss patent, but furthermore it comprises a step of confirming that the device has been correctly placed in the cold chamber, in this case a freezer. The reason for this is that, in the method disclosed in the Swiss patent, it is not possible to know whether the step of turning over the egg-timer so as to place the detection liquid in the upper part has been forgotten (the detection liquid being in the solidified state in the lower part if this step has been forgotten) or whether the contents of the freezer have undergone a momentaneous rise in temperature, due to a power cut for example, which has had the effect of liquefying the detection substance. When the freezer once again reaches its preservation temperature, the detection liquid located in the lower part solidifies again and it is impossible to know what has actually happened. Due to the presence of a step of confirming that the detection liquid has been placed in the upper zone in the aforementioned EP patent, a simple glance is all that is required in order to know whether the turning-over step has been carried out or whether defrosting, i.e. a rise in temperature, has occurred in the freezer.

Unfortunately, the method described in the European patent does not actually make it possible to know what rise in temperature the freezer has undergone. It is not possible to know whether the contents of the freezer must be destroyed due to a risk of food poisoning or whether merely the taste of the contents has been altered. The change in taste may not be an important criterion for some consumers. It is important that these consumers can have the choice of still consuming this product, since the latter does not present a risk to health.

Other methods also exist, such as methods which are implemented directly by freezers which comprise a means to indicate a rise in temperature by way of a warning light or an audible signal. Unfortunately, in the event of a prolonged absence or of an absence that is sufficiently long for the preservation temperature to be re-established, the consumer will not be alerted to the rise in temperature that the contents of his freezer have undergone.

Furthermore, in the event of a power cut, most alert signals are triggered only once the freezer has been switched back on, and if the consumer returns home during the power cut he will not know the current stage of defrosting of the contents of the freezing chamber and it would be risky to transfer said contents to another chamber.

Other complex methods also exist, such as methods comprising a measurement step by means of temperature probes, a step of recording the temperature at each moment in time and a step of indicating an anomaly for a relatively long time, at least long enough for a user to become aware of the anomaly, but these methods are expensive and are difficult to implement in the homes of individuals, and untrained persons find them difficult to use. Furthermore, these devices are bulky and are difficult to manufacture.

With the rules, regulations and standards regarding hygiene and quality, no longer can any risk be taken either with selling a product with an altered taste or with a risk of food poisoning. Manufacturers therefore demand that retailers and transporters destroy any products at risk, and there is a real need for a simple and inexpensive device which requires only a simple glance in order to ascertain not only that a rise in temperature has occurred but also the magnitude of this risk in temperature, and to do so without any ambiguity.

The object of the invention is to remedy the drawbacks of the prior art by providing a method for detecting a break in the chain of cold which makes it possible to detect a small rise in temperature in a substantially precise manner, i.e. which makes it possible to know easily whether the product is unfit for consumption due to a risk of food poisoning or whether the product simply risks having an altered taste. It is also advantageous to know whether the device has been correctly positioned in the cold chamber to be monitored. Finally, with preference, the device is simple and inexpensive to manufacture and use.

In order to solve this problem, there is provided according to the invention a method as indicated in the introduction, further comprising a quantification of the rise in temperature that has occurred inside the cold chamber by determining said displaced volume of liquefied detection substance.

The reason for this is that the detection substance, when it is placed in a first zone of the cold chamber, is selected so as to be in the solid state at the preservation temperature. The first zone is located above the second zone. When the contents of the chamber to be monitored undergo a rise in temperature, the detection substance will also undergo the same rise in temperature. This will have the effect of liquefying at least part of the detection substance. The liquefied quantity of substance will occupy a certain volume and this volume will have a tendency to flow downwards under the effect of gravity and will thus be displaced into the second zone located below the first zone in which it was located in the solidified state prior to the rise in temperature. The volume of the detection substance that has been displaced will then be determined and, because it is proportional to the rise in temperature undergone by the detection substance, it will be possible to quantify the rise in temperature that the products contained in the cold chamber have undergone or that the cold chamber has undergone.

Advantageously, during said determination, in the presence of a first displaced volume of liquefied detection substance that is less than a predetermined limit, a first rise in temperature is quantified as corresponding to a rise having a minor consequence for the product and, in the presence of a second displaced volume of liquefied detection substance that is greater than said limit, a second rise in temperature is quantified as corresponding to a rise in temperature having a detrimental consequence for the product.

The method according to the invention therefore makes it possible to quantify into two categories the rise in temperature that has been undergone. If a first volume of detection substance has been liquefied, that is to say a volume less than a volume corresponding to the predetermined limit, the rise in temperature that has been undergone is small. This will be the case for example for a freezer having contents at a preservation temperature of −24° C. and in which the first volume of detection substance that has been liquefied corresponds to a rise in temperature of 1 to 6° C. This rise in temperature is considered to be a rise in temperature that alters the taste of the product but is not considered to be a rise that presents a risk of food poisoning for the consumer.

If a second detection volume has been liquefied, that is to say a volume greater than the predetermined limit, the rise in temperature that has been undergone is greater. For example, for a freezer having contents at a preservation temperature of −24° C., the second volume of detection substance that has been liquefied will correspond to a rise in temperature of more than 6° C. This rise in temperature is considered to be a rise in temperature that presents a risk of food poisoning for the consumer.

The volume of liquefied detection substance will also depend of course on the volume of this substance in the solid state in the first zone, and therefore the aforementioned predetermined volume limit will also vary as a function of this parameter.

In one advantageous embodiment, the detection substance has a first viscosity when it undergoes said first rise in temperature and the detection substance has a second viscosity, lower than the first viscosity, when it undergoes the second rise in temperature.

It is therefore possible to determine the rise in temperature by determining the viscosity.

For example, according to the invention, during said displacement from the first zone to said second zone, the method comprises a confinement of the displaced volume of detection substance in a third zone located between said first zone and said second zone, when said detection substance has a viscosity higher than said second viscosity.

This is because, when the detection substance has a viscosity higher than the second viscosity, this means that it has undergone one or possibly several rises in temperature, but each without a risk of food poisoning.

Therefore, if screening means based on the viscosity are used for example, it is possible to confine the liquefied detection substance in an intermediate zone referred to as the third zone, the third zone and the second zone being separated by the viscosity screening means. The substance that has undergone a minimal rise in temperature therefore has a viscosity that is too high to pass through the screening means, whereas the substance that has undergone a rise in temperature presenting risks for the food to be preserved, due to its lower viscosity, will be able to pass through the screening means and reach said second zone.

Furthermore, it may be provided according to the invention that the third zone also has a graduation. It may therefore be possible to know either the duration of the rise in temperature below 6° C. or to know whether several rises in temperature below 6° C. have occurred one after the other. This is because, when the rise in temperature does not exceed 6° C., the detection substance does not have a sufficiently low viscosity to pass through the viscosity screen. The quantity of detection substance present above the viscosity screen will be an indication of the total duration of the one or more rises in temperature.

It will be understood that, in the sense of the invention, the expression “determining the displaced volume of liquefied detection substance” can mean not only measuring the volume of the liquefied substance but also measuring the displacement of this volume in space (as far as the third or the second zone) or else for example measuring the duration of its displacement (graduation in the third zone).

In another advantageous embodiment, the method according to the invention comprises, before said liquefaction, a solidification of the detection substance in the liquid state and an irreversible marking of the solidified liquid.

The irreversible marking during the solidification means that, during the at least partial liquefaction of the detection substance, the latter is also marked. This is because, at the time of placing the device in the cold chamber, the detection substance is in the liquid state and a marker is present. For example, the marker will be a pocket of dye. When the detection substance reaches the preservation temperature, the pocket of marker will burst and, when the liquid subsequently liquefies and is displaced, the same will be true of the marker. Therefore, if the detection substance in the second zone or in the third zone is marked, regardless of whether it is in the liquid state or is now solid again, it will not be possible to declare, for example during a hygiene check, that the step of placing the detection substance in the first zone was forgotten.

The method according to the invention is therefore a method which cannot be falsified and which guarantees the detection of any rise in temperature.

The present invention also relates to a device for implementing the method according to the invention. The device to be placed inside a cold chamber having a preservation temperature that is to be monitored according to the invention comprises:
a first compartment for containing, in the solid state, a detection substance for detecting a break in the chain of cold, and
a second compartment located below said first compartment and arranged so as to receive a displaced volume of detection substance in the liquid state when said detection substance has been liquefied following a rise in temperature.

This device is characterised in that it furthermore comprises means for quantifying the rise in temperature that has occurred inside the cold chamber by determining said volume of detection substance that has been liquefied.

This is because, by determining the volume of detection substance that has been liquefied and displaced into the second compartment, it will be possible to determine what rise in temperature has actually occurred inside the chamber to be monitored.

Advantageously, the quantification means consist of at least one graduation of said second compartment which represents a predetermined limit.

The presence of at least one graduation representing a predetermined limit, for example a predetermined volume limit, means that it will be possible to determine whether a first volume less than the predetermined volume limit has been liquefied and displaced or whether a second volume greater than the predetermined volume limit has been liquefied and displaced. Obviously the predetermined limit has been calibrated as being a displaced volume limit corresponding to a critical rise in temperature. This means that, if the contents of the cold chamber undergo a rise in temperature greater than this critical rise in temperature, said contents present a risk of food poisoning when they are consumed or a risk of dangerous alteration for the contents and, if said contents undergo a rise in temperature less than this critical rise in temperature, only the taste for example of the contents will be altered or slightly attenuated.

In one particularly advantageous embodiment, the device comprises a third compartment located between the first and the second compartment, the second and third compartments being separated by a viscosity screen.

In this embodiment, the quantification means make it possible to quantify a viscosity in addition to the predetermined volume. The viscosity screen allows the detection substance to pass if said detection substance has a viscosity lower than a predetermined viscosity which corresponds to a critical rise in temperature. Therefore, if the detection substance has a viscosity higher than the predetermined viscosity, it will not be able to pass through the viscosity screen and will remain confined above the screen when it is displaced towards the second compartment. The space located above the viscosity screen is referred to as the third compartment. If the displaced volume of detection substance is located in the third compartment, it has or has had at some given point in time a viscosity higher than the predetermined viscosity, which means that the detection substance and therefore the contents of the cold chamber to be monitored have not undergone a rise in temperature greater than the critical rise in temperature. On the other hand, if the displaced volume of detection substance is located in the second compartment, it has a viscosity lower than the predetermined viscosity and the displaced volume has passed through the screen. This means that the detection substance and therefore the contents of the cold chamber to be monitored have undergone a rise in temperature greater than the critical rise in temperature.

Preferably, the first compartment is separated from the second compartment by at least one constriction which prevents the solidified detection substance located in the first zone from being displaced, in the solidified state, into the subsequent zone, that is to say the second or the third zone depending on the case.

Other embodiments of the device and of the method according to the invention are indicated in the appended claims.

Other features, details and advantages of the invention will emerge from the description which is given below by way of non-limiting example and with reference to the appended drawings.

FIG. 1 is a perspective view of a device according to the invention in the solidification position.

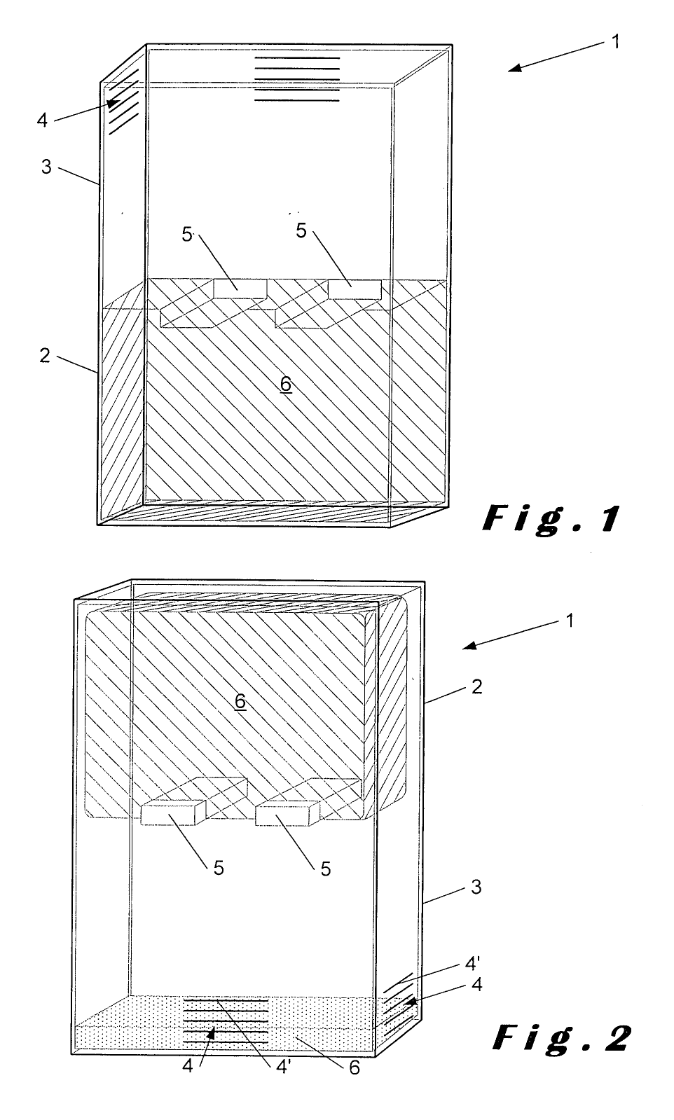

FIG. 2 is a perspective view of the device shown in FIG. 1 in the detection position and having undergone a rise in temperature.

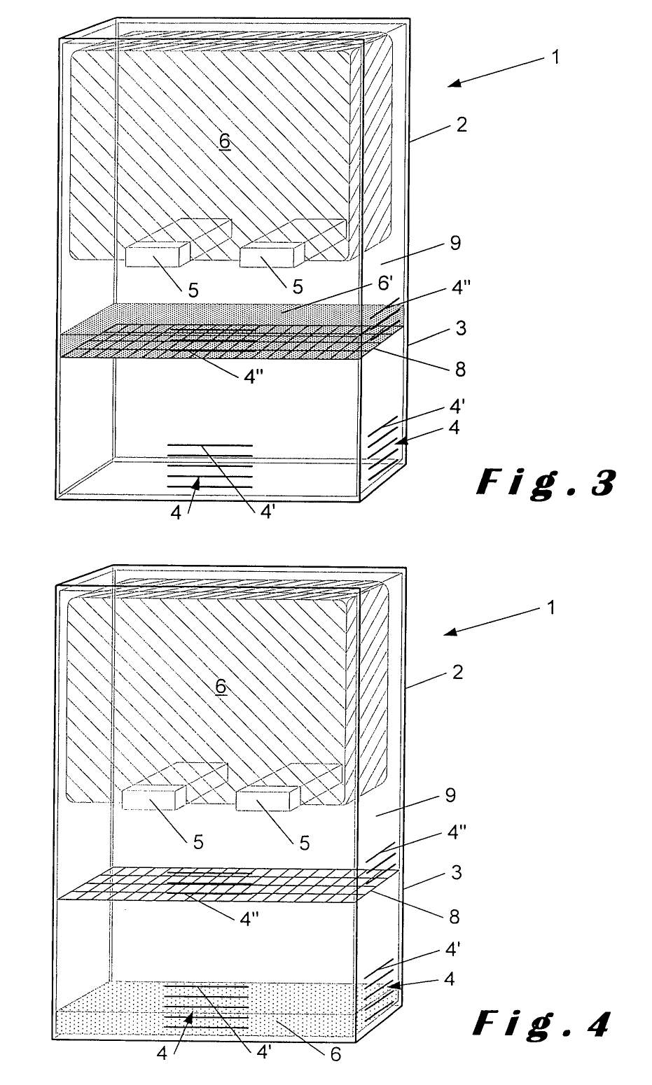

FIG. 3 is a perspective view showing a preferred embodiment in which the device in the detection position comprises three compartments and has undergone a first rise in temperature.

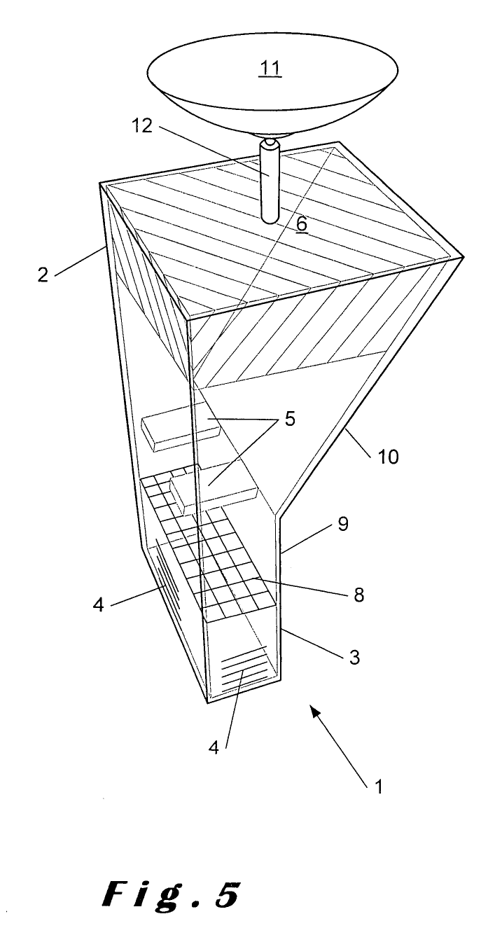

FIG. 4 is a perspective view of the preferred embodiment of the device shown in FIG. 3 having undergone a second rise in temperature.

FIG. 5 is a perspective view of a preferred embodiment with compartments having different geometries.

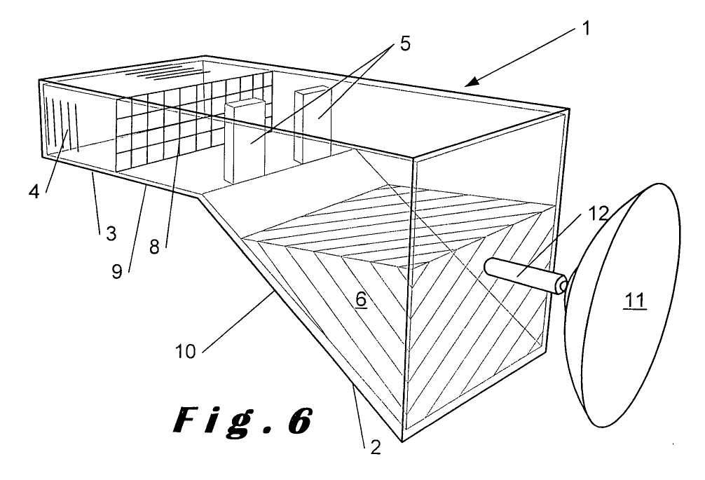

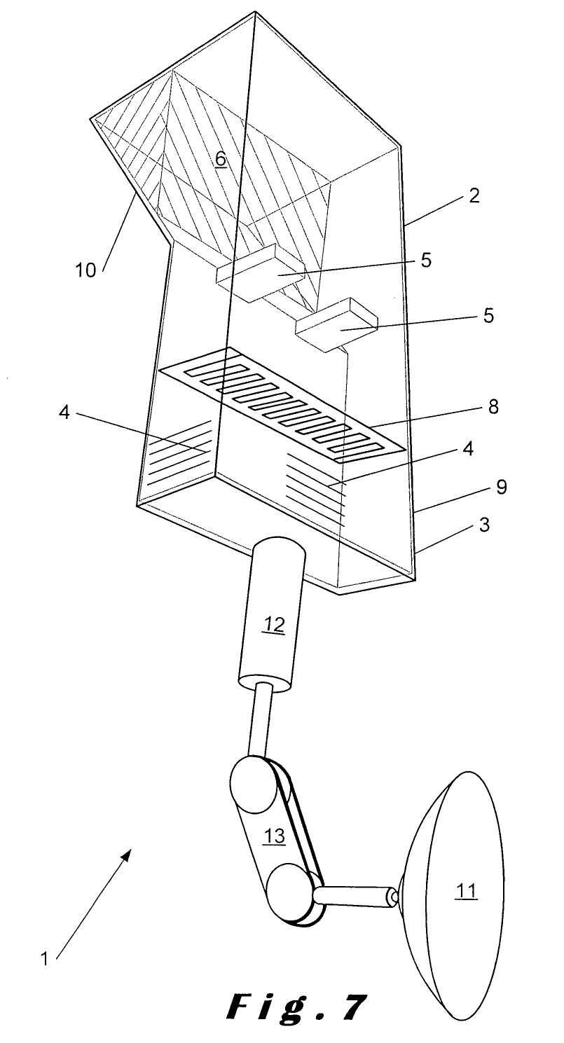

FIG. 6 is a perspective view of the embodiment shown in FIG. 5 in a solidification position.

FIG. 7 is a perspective view of the embodiment shown in FIG. 5 in the detection position, further comprising the means for passing from one position to the other and for fixing in position.

In the figures, identical or analogous elements bear the same references.

As can be seen in FIG. 1, the device 1 for detecting a break in the chain of cold comprises a first compartment 2 and a second compartment 3. The second compartment comprises quantification means 4 which consist of at least one graduation.

In the illustrated embodiment, the quantification means consist of a series of graduations 4, but it is understood that a single graduation that is well-positioned and represents a predetermined limit is sufficient. The first compartment 2 and the second compartment 3 are separated by two protrusions 5 which play the role of a constriction so as to prevent the displacement of the solidified detection substance towards the second compartment 3 when the device is in the detection position (see FIG. 2). It is clear that, in the absence of such a protrusion 5, if the block falls all at once, it is not possible to quantify easily the rise in temperature since the graduation 4 reached by the level of liquid and the block will be a graduation above that corresponding to the rise in temperature that has actually occurred. Here, two protrusions are shown, but a single protrusion is sufficient. Of course, the device 1 may comprise more protrusions.

Likewise, the device 1 may comprise a first compartment 2 that is conical, and the tip of the cone would therefore play the role of the constriction.

In FIG. 1, the protrusions 5 extend over the entire width of the device 1, but they may be of any size provided that they extend slightly from the wall on which they are located, which may be any wall of the device 1, that is to say on a front wall, a back wall or on one of the side walls when the device is placed vertically.

In FIG. 1, the device 1 contains a detection substance 6 which is in the first compartment 2, and the first compartment 2 is at the bottom. The device 1 is therefore in the solidification position and must be placed this way up in the cold chamber in order to solidify.

The detection substance 6 is selected so as to be solid at the preservation temperature, which is the temperature of the cold chamber to be monitored, and so as to liquefy under the effect of a rise in temperature.

In FIG. 2, the device is in the detection position. It has been turned over so as to allow the liquefied detection substance 6 to flow downwards if some of it defrosts, that is to say if the device 1 undergoes a rise in temperature.

As shown here, the device 1 has undergone a rise in temperature which has caused the displacement of a volume of detection substance 6′ into the second compartment 3.

According to the invention, it is provided that, when a rise in temperature of 1° C. to 6° C. occurs, a volume of detection substance 6 is displaced from the first compartment 2, located above the second compartment 3, towards the second compartment 3. This detection volume must be less than a predetermined limit in order for it to be considered that the rise in temperature has not reached the critical threshold.

In the example of FIG. 2, the last graduation 4′ is a graduation corresponding to a critical rise in temperature, and therefore the contents of the cold chamber have in this case undergone a rise in temperature less than the critical rise, since the level of detection substance in the second compartment 3 is below the last graduation 4′.

In the case of a freezer for food products at −24° C., the predetermined limit corresponds to the displaced volume of detection substance when the chamber is at −18° C., that is to say when a rise in temperature of 6° C. has occurred. This is because it is known that, starting from a rise in temperature of more than 6° C., the preserved product presents a risk of food poisoning when it is consumed. For a rise in temperature of less than 6° C., it is the taste of the preserved product that is altered. Of course, the device may also be placed in a chamber of a laboratory at −24° C., for example containing strains of bacteria or yeast or else proteins, markers, antibiotics, vaccines or other substances. In this case, depending on the rise in temperature that will be critical for the contents of the chamber, a detection substance will be selected which will be liquid at the critical temperature and solid at the preservation temperature.

The device according to the invention may also be placed in colder chambers, for example chambers at −80° C. or −35° C.

For example, it is envisaged according to the invention that the device can be placed respectively in food preservation chambers having a temperature of −24° C., −18° C., −12° C. and −6° C., which correspond to the respective classification of four stars, three stars, two stars and one star.

For a chamber at −80° C., it is known that the critical temperature is a temperature around −60° C. At this temperature, the frozen cells suffer greatly and they should not be placed back in a culture. The detection substance will therefore be provided so as to be in the liquid state at −60° C. and in the solid state at −80° C.

Preferably, the detection substance is a mixture of water and a component selected from an alcohol or a polyol at a concentration in the range from 99.9 to 0.1% by weight, preferably from 65% to 15%, said detection substance being provided so as to be at least in the liquid state at the ambient temperature, and the alcohol or polyol concentration being selected as a function of the temperature to be monitored.

In the case of a chamber at −24° C., the quantity of alcohol or polyol present in the detection substance will be smaller than in the case of a chamber to be monitored at −80° C. It is also clear that the concentration will also depend on the rise in temperature that is to be detected and on the critical viscosity that is to be achieved.

The alcohol or polyol are preferably to be selected from ethyl alcohol, isopropyl alcohol, butyl alcohol, isoamyl alcohol, propylene glycol and glycerol.

As mentioned previously, the composition of the substance will depend on the preservation temperature in the cold chamber and on the critical temperature difference.

Examples of detection substances include, without being limited thereto, a water/glycerol mixture comprising approximately 49% water and approximately 51% glycerol (T=−24° C., ΔT=6° C.), a water/isopropanol mixture comprising approximately 1% water and approximately 99% isopropanol (T=−85° C., ΔT=20° C.) and a mixture of an oily substance and saccharose or a water/glycerol mixture comprising 1% water and 99% glycerol (T=4° C., ΔT=4° C.) or else a substance comprising water, sucrose, fructose and saccharose (T=4° C., ΔT=4° C.). For a chamber at −55° C., the mixture will consist for example of 5% water and 95% propylene glycol.

In one preferred embodiment, the device according to the invention furthermore comprises, in the first compartment, a pocket which contains dye, said dye-containing pocket being provided so as to burst during the solidification of the detection substance and the dye is provided so as to mix at least partially with the detection substance when the latter is in the liquid state. The pocket of dye may be spherical (a bead) or of any other shape.

Therefore, when the detection substance undergoes a rise in temperature, the displaced detection substance is dyed irreversibly and it is not possible to hide the fact that there has been a rise in temperature inside the cold chamber to be monitored, even if said detection substance has again solidified following reestablishment of the preservation temperature. The person skilled in the art will recognise that the dye may be contained in a pocket, preferably a slightly flexible pocket, which may be fixed in the first compartment or may be in suspension or in solution in the detection substance. The device therefore cannot be falsified on account of this dyeing action.

As the dye, it is possible to use any known dye that is suitable, for example fluorescein, eosin, rhodamine, quinoline, methyl orange, methylene blue, alizarin.

The pocket of dye is provided so as to confine the dye therein in order to prevent it from mixing with the detection substance at the ambient temperature at which the device 1 is to be kept. It is possible to envisage using a pocket made from plastic or polymer with little stretchability or from any type of material that is not soluble in the detection substance. When the device according to the invention is placed in the cold chamber with a view to its solidification, it is intended that the detection substance will exert a pressure on the material of the pocket and this pressure will cause the rupture of the pocket of dye. The rupture may also be caused by a solidification of the dye. The rupture of the pocket then causes the propagation of the dye into the detection substance.

Advantageously, the pocket or bead will be completely filled, for example with dye or with an air/dye mixture, so as to promote the bursting thereof when pressure is exerted by the solidified detection substance. Furthermore, it may be envisaged that the pocket or bead is ruptured by a tear created by crystals of solidified substance, whether these be crystals of dye or of detection substance 6 or of both.

The dye contained in the bead will preferably be in a fairly incompressible state, but it is envisaged according to the invention that it is in the gas, liquid or solid state. In all cases, it will preferably be liquid at the critical temperature, but it may also be solid so as to form a suspension instead of a mixture.

FIGS. 3 and 4 illustrate a preferred embodiment of the device according to the invention. In this embodiment, the device 1 comprises a viscosity screen 8.

The viscosity screen allows the detection substance to pass if the latter has a viscosity lower than a predetermined viscosity limit which corresponds to a critical rise in temperature. In the case of a cold chamber at −24° C., the critical rise in temperature is 6° C. as mentioned above. A viscosity of the detection substance 6 which is the predetermined viscosity, that is to say the viscosity of the detection substance at −18° C., corresponds to this rise in temperature of 6° C. Therefore, if the detection substance has a viscosity higher than the predetermined viscosity limit, it will not be able to pass through the viscosity screen. This is the situation shown in FIG. 3. The detection substance will remain confined to above the screen during its displacement towards the second compartment. The space located above the viscosity screen is referred to as the third compartment 9. If the displaced volume of detection substance 6 is located in the third compartment 9, it has a viscosity higher than the predetermined viscosity and this means that the detection substance and therefore the contents of the cold chamber to be monitored have not undergone any rise in temperature greater than the critical rise in temperature of 6° C. The contents therefore have qualities that have been slightly altered but are not dangerous. Furthermore, the third compartment 9 may comprise a series of graduations 4″ which make it possible to quantify the duration of the non-critical rise in temperature or the total duration of the consecutive non-critical rises in temperature.

On the other hand, as shown in FIG. 4, if a displaced volume of detection substance 6 is located in the second compartment 3, this means that it has had a viscosity lower than the predetermined viscosity and the displaced volume of detection substance 6 has passed through the screen 8. The detection substance 6 and therefore the contents of the cold chamber to be monitored have therefore undergone a rise in temperature greater than the critical rise in temperature. The contents of the chamber therefore present a risk, for example when consumed or used.

As can be seen in FIG. 5, which shows the device 1 in the detection position once said device has been placed in the cold chamber in the vertical solidification position, it is also provided according to the invention that the device 1 comprises a first compartment 2 which has a geometry different from the second compartment 3. This makes it possible for the consumer to be able to actually know whether he has forgotten to turn the device 1 over into the detection position if the detection substance 6 is located in the second compartment 3. This is because, when the device is placed in the solidification position, the first compartment 2 is at the bottom. Once the detection substance 6 has solidified, the device is turned over into the detection position, i.e. the first compartment 2 is placed at the top.

If the two compartments 2 and 3 are of identical geometry, it is not possible when the detection substance 6 is in the solidified state in the second compartment 3 to know whether the device 1 has been turned over into the detection position, if it has undergone a rise in temperature that has displaced the detection substance 6 into the second compartment 3 and if the detection substance 6 has re-solidified because the temperature has returned to normal, or whether the step of turning the device 1 over into the detection position has been forgotten.

By contrast, if the two compartments 2 and 3 are of different geometry, and if the detection substance 6 is in the solidified state in the bottom compartment and the latter has the geometry corresponding to the first compartment 2, then the device has not been turned over. If the bottom compartment has the geometry of the second compartment 3, then a rise in temperature has occurred.

It is also provided according to the invention that, instead of a different geometry, the two compartments 2 and 3 are differentiated by identification means such as letters, numbers or colours or else by a symbol or logo.

Advantageously, as can be seen in FIG. 5, one of the walls 10 of the first compartment 2 has a slope which promotes the displacement of the detection substance 6 towards the second compartment. Furthermore, the device 1 according to the invention comprises fixing means consisting of a suction cup 11 which makes it possible to place the device in the cold chamber and to replace the device 1 when the latter has undergone a rise in temperature.

Therefore, in the embodiments shown in FIGS. 1 and 2, determining the displaced volume may mean of course measuring the volume value. However, as can be seen in the other figures, determining the displaced volume may mean a spatial determination of the location where the volume has been displaced (compartment 3 or 9), the location corresponding to a particular rise in temperature, or else a determination of the duration over which a volume of detection substance has been liquefied in a non-critical manner (graduation 4″ in FIG. 3).

FIG. 6 is an embodiment of the device according to the invention which also comprises a suction cup 11. In the illustrated embodiment, the suction cup easily allows a solidification of the detection substance 6 in the detection position, which in this alternative is a horizontal position as shown.

In this alternative, it is even easier to detect when the step of placement in the solidification position has been forgotten.

The device 1 is connected to the suction cup 11 by an articulated arm 12 which makes it possible to easily place the device 1 in the detection position, that is to say in the vertical position with the first compartment 2 at the bottom, and then to return it to the solidification position, in this case the horizontal position.

One particularly preferred embodiment is shown in FIG. 7. The device 1 according to the invention is in the detection position. The device comprises an arm 12 connected to a detent hinge 13 which is in turn connected to the suction cup so as to attach the device to one of the walls of the cold chamber. The detent hinge 13 makes it possible to pivot the device 1 from the horizontal solidification position to the vertical detection position and vice versa, while locking it in one of these two positions so as to prevent it from returning under the effect of its own weight. The detent hinge may also be provided for making the device pass from its vertical solidification position to its inverted vertical detection position. In this case, it will likewise lock the device in these two positions.

It will be understood that the present invention is in no way limited to the embodiments described above and that numerous modifications may be made thereto without departing from the scope of the appended claims. For example, it may also be provided that the device according to the invention comprises a vent for allowing an inlet of air or an outlet of air which facilitates the displacement of the detection substance from one compartment to another, always with the aim of providing the best possible detection threshold with an equally simple device. This would make it possible to prevent any slowing or obstruction of the displacement of the detection substance when there is a pocket of air in the second compartment or in the third compartment.

1. Method for detecting a rise in temperature in a cold chamber intended for preserving products, comprising:
partially liquefying a detection substance housed in a first zone of said chamber by a rise in temperature in said cold chamber,
displacing a volume of liquefied detection substance into a second zone of said chamber, thereby allowing detection of said rise in temperature, and
quantifying the rise in temperature that has occurred inside the cold chamber by determining said displaced volume of liquefied detection substance.

2. Method according to claim 1, in which, during said determination, in the presence of a first displaced volume of liquefied detection substance that is less than a predetermined limit, a first rise in temperature is quantified as corresponding to a rise having a minor consequence for the product and, in the presence of a second displaced volume of liquefied detection substance that is greater than said limit, a second rise in temperature is quantified as corresponding to a rise in temperature having a detrimental consequence for the product.

3. Method according to claim 2, in which the detection substance has a first viscosity when it undergoes said first rise in temperature and the detection substance has a second viscosity, lower than the first viscosity, when it undergoes the second rise in temperature.

4. Method according to claim 3, furthermore comprising, during said displacement from the first zone to said second zone, a confinement of the displaced volume of detection substance in a third zone located between said first zone and said second zone, when said detection substance has a viscosity higher than said second viscosity.

5. Method according to claim 1, furthermore comprising, before said liquefaction, a solidification of the detection substance in the liquid state and an irreversible marking of the solidified liquid.

6. Temperature rise detection device (1) for to be placed inside a cold chamber having a preservation temperature that is to be monitored, comprising:
a first compartment (2) for containing, in the solid state, a detection substance (6) for detecting a break in the chain of cold, and
a second compartment (3) located below said first compartment and arranged so as to receive a displaced volume of detection substance (6′) in the liquid state when said detection substance (6) has been liquefied following a rise in temperature,
and further comprising means for quantifying the rise in temperature that has occurred inside the cold chamber by determining said displaced volume of liquefied detection substance (6).

7. Device (1) according to claim 6, in which the quantification means consist of at least one graduation (4) of said second compartment which represents a predetermined limit (4′).

8. Device (1) according to claim 6, furthermore comprising a third compartment (9) located between the first (2) and the second compartment (3), the second (3) and third compartments (9) being separated by a viscosity screen (8).

9. Device (1) according to claim 6, furthermore comprising, in the first compartment (2), a pocket which contains dye, said dye-containing pocket being provided so as to burst during a solidification of the detection substance (6) and the dye being provided so as to mix at least partially with the detection substance (6) when the latter is in the liquid state.

10. Device (1) according to claim 6, in which the first compartment (2) is separated from the second compartment (3) by at least one constriction (5) which prevents the solidified detection substance (6) located in the first zone from being displaced, in the solid state, into the subsequent zone.

11. Device (1) according to claim 6, having a detection position in which the first compartment (2) is above the second compartment (3) and a solidification position which is different from the detection position, and in which passage means (11, 12) are provided for making the device pass from the detection position to the solidification position and vice versa.

12. Device (1) according to claim 6, in which each compartment has at least one wall provided with unique identification means.

13. Device (1) according to claim 6, in which the first compartment comprises at least one wall (10) at a slope relative to the vertical so as to facilitate said displacement of said volume of detection substance (6).

14. Device (1) according to claim 6, in which the first compartment (2) has a geometry that is different from the second compartment (3).
